(19) United States
(12) Patent Application Publication
(10) Pub. No.: US 2012/0167708 A1
(43) Pub. Date: Jul. 5, 2012

(54) DEVICE FOR GENERATING AN ADDITIONAL RESTORING FORCE AT THE GAS PEDAL AND METHOD FOR THE OPERATION THEREOF

(75) Inventors: Thomas Brandt, Edelsfeld (DE); Frank Drews, Rothenbach (DE); Tobias Düser, Bensheim (DE); Jens Schröter, Karlsbad (DE); Christian Zingel, Karlsruhe (DE); Alexander Schwarz, Tiefenbronn (DE); Sascha Ott, Bad Herrenalb (DE); Andreas Zell, Nurnberg (DE); Carmelo Leone, Freising (DE)

(73) Assignee: Conti Temic Microelectronic GmbH, Nurnberg (DE)

(21) Appl. No.: 13/382,168

(22) PCT Filed: Jul. 7, 2010
(86) PCT No.: PCT/EP2010/059760

§ 371 Date: Mar. 16, 2012

(30) Foreign Application Priority Data
Jul. 9, 2009 (DE) 10 2009 032 676.6
Jul. 22, 2009 (DE) 10 2009 034 497.7

(51) Int. Cl. G05G 1/30

(52) U.S. Cl. 74/513

(57) ABSTRACT

A device and method for generating an additional restoring force at the gas pedal for motor vehicles, wherein a change in position of the gas pedal relative to its initial position, brought about by a corresponding activation force counter to a restoring force, leads to an increase in the driving force of the drive engine, and when the activation force diminishes a restoring force returns the gas pedal in the direction of its initial position. An actuator element is provided which applies an additional restoring force which acts in the restoring direction of the gas pedal. For energy efficiency, the invention provides that the magnitude of the additional restoring force (F) acting on the gas pedal is configured such that the gas pedal assumes a position which moves the operating point of the drive engine into a region with a relatively high efficiency level.

### CROSS REFERENCE TO RELATED APPLICATIONS

This application is the U.S. National Phase Application of PCT International Application No. PCT/EP2010/059760, filed Jul. 7, 2010, which claims priority to German Patent Application No. 10 2009 032 676.6, filed Jul. 9, 2009, and German Patent Application No. 1 034 497.7, filed Jul. 22, 2009, the contents of such applications being incorporated by reference herein.

### FIELD OF THE INVENTION

The invention relates to a device for generating an additional restoring force at the gas pedal for motor vehicles, wherein a change in position of the gas pedal relative to its initial position, which change is brought about by a corresponding activation force counter to a restoring force, leads to an increase in the driving force of the drive engine, and when the activation force diminishes a restoring force returns the gas pedal in the direction of its initial position, and wherein an actuator element is provided which applies an additional restoring force which acts in the restoring direction of the gas pedal. Furthermore, the present invention relates to a method for operating same.

### BACKGROUND OF THE INVENTION

DE 32 32 160 A1, which is incorporated by reference, therefore discloses a method in which the restoring force of the accelerator pedal can be changed and the vehicle driver is provided with haptic feedback. The restoring force of the accelerator pedal is set, in the region of the full pedal travel, automatically as a function of characteristic variables which represent the engine torque and the engine speed. In the previously known method, the vehicle driver is provided with information, for example about the selection of the gear speed, in the form of movements, for example vibrations, which are superimposed on the pedal travel.

An Internet publication (http://www.nissan-global.com/EN/NEWS/2008/STORY/080804-02-e.html), which is incorporated by reference, discloses what is referred to as an ECO pedal. In this ECO pedal, a target corridor is calculated for the gas pedal position, which corridor is limited by a maximum gas pedal position. If the vehicle driver is located in the specified target corridor during an acceleration process or during travel at a constant speed, only a monitoring light on a display instrument lights up green. If the vehicle driver approaches an upper threshold, the monitoring light begins to flash, and then an additional restoring force on the gas pedal indicates to the driver that he is leaving the efficient range. If the vehicle driver therefore reduces the gas pedal position, the additional restoring force disappears. In contrast, if the vehicle driver depresses the pedal beyond the threshold value, an increased additional restoring force is applied from then on to the gas pedal, which additional restoring force is composed of the normal passive control force of the pedal and the additional restoring force when the threshold value is reached. The threshold value is calculated here from the consumption and the efficiency level of the drive train. In contrast, there is no provision for the switching strategy to be adapted with the previously known ECO pedal. Furthermore, all that is predefined is a target corridor which is calculated according to minimum specific consumption and which does not sufficiently take into account the dynamics of the acceleration. There is no interaction with other road users.

It has become apparent that the methods which have become known do not meet a series of requirements which are made in practice. An aspect of the present invention is therefore to present a method and a device which achieve a relatively high energy saving of the drive engine.

### SUMMARY OF THE INVENTION

This aspect is achieved by means of a method and a device having an additional restoring force at the gas pedal for motor vehicles, wherein a change in position of the gas pedal relative to its initial position, which change is brought about by a corresponding activation force counter to a restoring force, leads to an increase in the driving force of the drive engine, and when the activation force diminishes a restoring force returns the gas pedal in the direction of its initial position, and wherein an actuator element is provided which applies an additional restoring force (F) which acts in the restoring direction of the gas pedal, wherein the magnitude of the additional restoring force (F) acting on the gas pedal is configured in such a way that the gas pedal assumes a position which moves the operating point of the drive engine into a region with a relatively high efficiency level. There is provision here that the magnitude of the additional restoring force acting on the gas pedal is configured in such a way that the gas pedal assumes a position which moves the operating point of the drive engine into a region with a relatively high efficiency level. In this context, allowance is made for the possibility that a profile which quickly moves through regions of relatively high specific consumption into the region of very low consumption is more economical in terms of energy overall.

One advantageous development provides that the magnitude of the additional restoring force acting on the gas pedal is set as a function of the driving situation and the traffic situation of the motor vehicle. Here, a negative additional restoring force acting on the gas pedal causes the vehicle driver to apply an activation force in the direction of increasing the driving force of the drive engine.

A fundamental inventive idea is that the driving situation of the motor vehicle is divided at least into acceleration travel, constant travel and deceleration travel. In this context there is provision that the magnitude of the additional restoring force acting on the gas pedal during acceleration travel is configured in such a way that the gas pedal assumes an optimum position, wherein this optimum position of the gas pedal is determined as a function of the efficiency level of the drive engine and preferably with the aid of characteristic diagrams determined in advance. During deceleration travel, the magnitude of the additional restoring force acting on the gas pedal is configured in such a way that the gas pedal assumes an unactivated position. In order to initiate the deceleration travel, a coasting distance before a stationary obstacle or an obstacle which is moving in the direction of travel of the motor vehicle is calculated and is compared with a coasting curve of the motor vehicle which is determined in advance.

There is provision that the driving situation is determined, on the one hand, on the basis of dynamic variables such as velocity, longitudinal acceleration, lateral acceleration and yawing moment and, on the other hand, on the basis of vehicle-internal variables such as engine control parameters and transmission control parameters.

In one particularly advantageous development of the invention, the traffic situation is determined by a surroundings sensor system for sensing the carriageway, the route, the road signs and/or the stationary or moving obstacles and/or road users. Alternatively or additionally, the traffic situation is determined with the aid of an electronically stored road map in conjunction with a satellite-supported position-determining system. Likewise, mobile-radio-supported systems or systems which are based on car-to-car communication could additionally or alternatively be used to determine the traffic situation. It is essential to the invention that the acceleration travel, constant travel or deceleration travel is detected as a function of the traffic situation, and the additional restoring force acting on the gas pedal is configured in such a way that the motor vehicle is guided in an energy-efficient fashion.

A further measure for energy-efficient use of the motor vehicle is achieved in that the gear speed to be selected in a manual transmission is proposed to the vehicle driver in the case of acceleration travel, constant travel and deceleration travel.

The aforementioned aspect is also achieved by means of a device wherein means are provided which configure the magnitude of the additional restoring force acting on the gas pedal in such a way that the gas pedal assumes a position which moves the operating point of the drive engine into a region with a relatively high efficiency level.

The means detect acceleration travel, constant travel or deceleration travel as a function of the driving situation and/or the traffic situation, and configure the additional restoring force (F) acting on the gas pedal in such a way that the motor vehicle is guided in an energy-efficient fashion.

In one particularly advantageous development there is provision that the means are embodied as controllers,
wherein the first controller outputs an additional restoring force (F) which corresponds to the optimum gas pedal position during acceleration and which acts on the gas pedal, and
wherein the second controller outputs an additional restoring force (F) acting on the gas pedal for the purpose of follow-on travel behind another road user, and
wherein the third controller outputs an additional restoring force (F) acting on the gas pedal in order to decelerate the motor vehicle, with the result that the gas pedal assumes an unactivated position, and
wherein the fourth controller outputs an additional restoring force (F) acting on the gas pedal, with the result that a speed which is set by a cruise controller is implemented, and
wherein a superordinate control unit is provided which activates or deactivates one or more controllers on the basis of the driving situation and/or the traffic situation.

A surroundings sensor system is provided which provides the superordinate control unit with information about the carriageway, the route, the road signs and/or the stationary or moving obstacles and/or road users.

### BRIEF DESCRIPTION OF THE DRAWINGS

The invention is best understood from the following detailed description when read in connection with the accompanying drawings. Included in the drawings is the following figures:

FIG. 1 shows a schematic illustration of a pedal system and of a device for generating an additional restoring force;

FIG. 2 shows a schematic sectional illustration of the pedal system from FIG. 1 in order to explain the method of functioning;

FIG. 3 shows a schematic illustration of a plurality of controllers and of a superordinate control unit;

FIG. 4 shows a time/travel diagram for calculating coasting distance;

FIG. 5 shows a diagram which contrasts the cumulated consumption with a distance travelled at an indicated speed, in a traffic situation with a temporary speed limit;

FIG. 6 shows a diagram which corresponds to FIG. 5, in a stop & go traffic situation, and

FIG. 7 shows a diagram which corresponds to FIG. 6, in the stop & go traffic situation with a shorter overall distance than in FIG. 6.

### DETAILED DESCRIPTION OF THE PREFERRED EMBODIMENTS

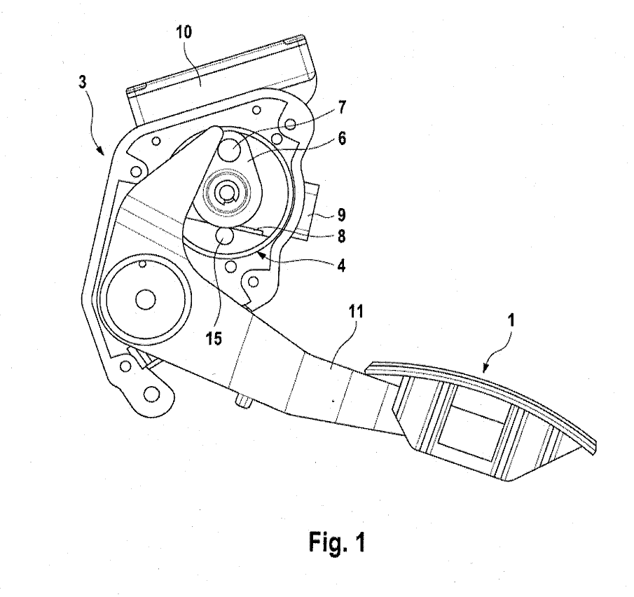

FIG. 1 shows a compact pedal system for generating an additional restoring force F at the gas pedal 1. For this purpose, a force restoring device is integrated in the housing 3. The pedal system essentially comprises a pedal lever 11 for converting the driver's request into speed of the motor vehicle. An electric motor 4, in particular a torque motor, as further component of the force-restoring device can, in the energized state, apply a restoring force to the pedal lever 11 or to the gas pedal 1 in the direction of a reduction in speed. A drive pulley 6 is rotatably arranged on the electric motor 4 and can apply the restoring force to the pedal lever 11 or to the gas pedal 1 by means of a drive roller 7. A control unit 10 for controlling the electric motor 4 is likewise integrated in the housing 3.

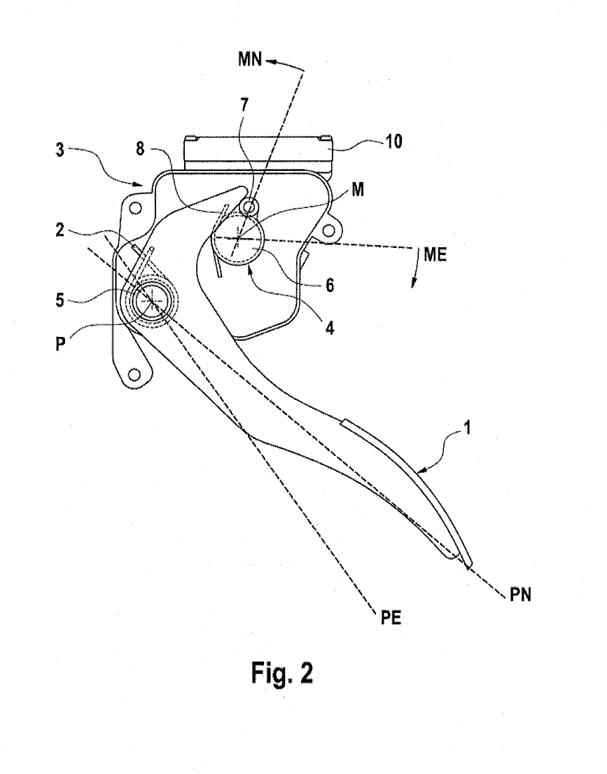

FIG. 2 shows a pedal system with a pedal lever 1 in its zero position PN. That is to say the vehicle driver's foot acting on the pedal lever 1 does not apply a force in the direction of increasing the speed, and the drive engine of the motor vehicle rotates at the idling speed. The pedal lever 1 can pivot about the center of rotation P, specifically from a zero position PN to the end position PE, which translated into engine speed means from idling to completely open throttle. In this case, a leg spring is arranged as a pedal return spring 2 at the center of rotation P of the pedal lever 1 in such a way that said leg spring pushes the pedal lever 1 into its zero position PN. Alternatively, a linearly acting spring would also be conceivable as a pedal lever return spring 2, in particular outside the center of rotation P. The electric motor 4 can pivot about its center of rotation M, specifically from its end position ME to its zero position MN. In the case described, the centers of rotation P and M of the pedal lever 1 and of the electric motor 4 are separated locally. However, a pedal system in which the two centers of rotation P and M coincide would be perfectly possible.

An engine return spring 8 is arranged on the electric motor 4 in such a way that the drive pulley 6 of the electric motor 4 also presses the pedal lever 1 in the direction of its zero position PN by means of the drive roller 7, in particular if the electric motor 4 is not energized. In this case, in each case one end of the pedal return spring 2 or engine return spring 8 is permanently connected to the housing 3, at least in the pressing direction of the spring 2, 8. The angular range which is determined by the respective zero position MN, PN and end position ME, PE of the springs 2, 8 is greater in the case of the engine return spring 8 than in the case of the pedal return spring 2 both with respect to the zero position MN and with respect to the end position ME. This ensures that the drive 6 bears on the pedal lever 1 via the drive roller 7 at any time. That is to say the engine return spring 8 is always prestressed at least in the non-energized state of the electric motor 4.

For the actuation of the electric motor 4 by a control unit 10 which is integrated into the pedal system, it is advantageous to sense the respective angular position both of the pedal lever 1 and of the electric motor 4 by, in each case, a corresponding sensor, for example by a Hall sensor. Corresponding sensors are, however, not illustrated in FIGS. 1 and 2.

The method described below is based on two fundamental ideas: the first idea is to divide the driving movement of a motor vehicle into a plurality of driving situations and to recommend a gas pedal position for each driving situation, which position is assumed taking into account a particularly efficient energy consumption of the drive engine. The recommended gas pedal position corresponds to the magnitude of the additional restoring force (F) acting on the gas pedal. The second idea is the networking with a surroundings sensor system for detecting the traffic situation for the purpose of saving energy by the drive motor. In this context, the surroundings sensor system detects other road users and road signs which indicate, for example, a speed limit.

The drive train in the motor vehicle, composed of the drive engine and transmission, has different efficiency levels at different engine torques and engine speeds. During operation, operating points with a very low efficiency level are often approached by the driver owing to a lack of system knowledge. This results in increased fuel consumption.

As a result of the method which is described in more detail below, the operating points are moved in a reproducible fashion into regions with a relatively high efficiency level, the losses are reduced and as a result the fuel consumption and/or energy consumption are lowered. This is done by direct prompting of the vehicle driver. The vehicle driver is prompted here by means of a device for generating an additional restoring force F at the gas pedal 1, as has been described with reference to FIGS. 1 and 2. A positive or negative additional restoring force F at the gas pedal prompts the driver to open the throttle to a greater or lesser degree. While a positive additional restoring force F at the gas pedal 1 prompts the vehicle driver to reduce the activation force at the gas pedal 1, a negative additional restoring force −F at the gas pedal 1 prompts the vehicle driver to activate the gas pedal 1 in the direction of increasing the driving force. This is dependent on the current driving situation. The driving situation is divided into acceleration travel, constant travel and deceleration travel. The magnitude of the additional restoring force F is set as a function of the driving situation and the traffic situation. The traffic situation is determined here using a surroundings sensor system, such as is also used in driver assistance systems and what are referred to as adaptive cruise control systems. Alternatively, the traffic situation can be determined with the aid of an electronically stored road map in conjunction with a satellite-supported position-determining system.

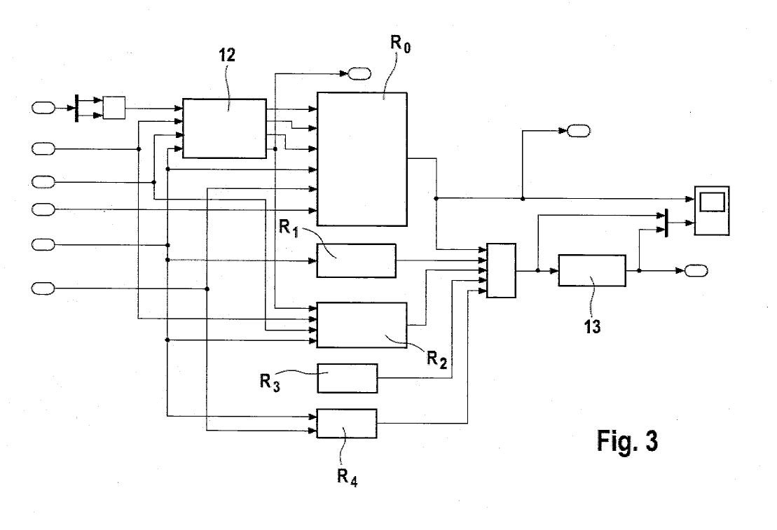

With reference to FIG. 3 it is now explained how the magnitude of the additional restoring force F is set as a function of the driving situation. As already mentioned, the driving situation of the motor vehicle is divided into acceleration travel when the motor vehicle is accelerating, constant travel when travelling at a constant speed and deceleration travel when the motor vehicle is being braked. Furthermore, follow-on travel is defined during which the motor vehicle travels behind another road user and follows this road user. Follow-on travel therefore describes a typical picture of traffic on country roads on which it is not possible to overtake. FIG. 3 illustrates four controllers R₁, R₂, R₃, R₄ and a superordinate control unit R₀. The controllers R₁, R₂, R₃, R₄ are responsible for the different above-mentioned driving situations and are retrieved by the superordinate control unit R₀. That is to say the detection of the driving situation and the decision as to which of the controllers R₁, R₂, R₃, R₄ mentioned below is to be actuated is taken by the superordinate control unit R₀.

The first controller R₁ outputs an additional restoring force F which corresponds to the optimum gas pedal position during acceleration. The vehicle driver is prompted by this additional restoring force F to move the gas pedal 1 into the optimum position which the first controller R₁ has calculated for the acceleration travel. This optimum gas pedal position during acceleration is determined using a characteristic diagram which has been determined in advance by a roller test bench. The optimum gas pedal position with respect to the efficiency level of the drive engine is obtained from the characteristic diagram. The second controller R₂ outputs the actuation signal for an additional restoring force F for the follow-on travel behind another road user. The second controller R₂ for coordinating the follow-on travel can be identical to a controller of a driver assistance system. The driver assistance system evaluates the data of a surroundings sensor system and continuously calculates the distance from a road user travelling in front. However, while the driver assistance system brings about braking of the motor vehicle, there is provision that for the purpose of bringing about follow-on travel an additional restoring force is output at the controller R₂, which restoring force prompts the vehicle driver to select a gas pedal position which prevents the vehicle from moving up too close behind the person in front. This measure makes it possible to dispense with braking of the motor vehicle, which is advantageous in terms of energy consumption criteria.

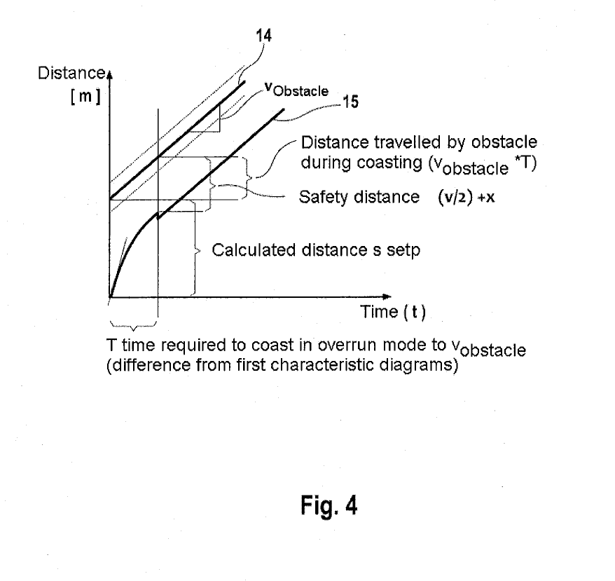

The third controller R₃ is responsible for initiating the deceleration travel: if the vehicle moves up too close to an obstacle, this controller R₃ becomes active. The controller R₃ outputs an additional restoring force, with the result that the gas pedal 1 assumes an unactivated position. The vehicle driver is therefore directed to take his foot completely off the gas pedal 1. A coasting distance calculation means 12 calculates whether the motor vehicle is to coast in the overrun fuel cutoff mode of the drive engine. In this context, reference is made to the calculation of a coasting distance in FIG. 4. As a function of the current distance from the obstacle, it is signaled to the controller selection means R₀ whether the vehicle should coast, whether the vehicle is in a range in which it can travel behind the obstacle in a follow-on travel mode or whether it is possible to accelerate further. In this context, the speed of the obstacle v_{Hindernis} and the time T which is required to change to the speed of the obstacle v_{Hindernis} are always taken into account. In the time/travel diagram illustrated in FIG. 4, the curve which is provided with the reference symbol 14 denotes the movement of the obstacle. The obstacle is in this case a vehicle travelling in front. The movement of the motor vehicle at the speed v is provided with the reference symbol 15. The time T which is required to coast to the vehicle traveling ahead at the speed v_{Hindernis} is obtained from the calculated or measured distance sₛₒᵢₗ between the vehicle and the obstacle. In this context, a safety distance s_{Srcherheit}=v/2+x, which is calculated from half the speed v of the motor vehicle and a safety distance x, is taken into account. Since coasting in the overrun mode of the drive engine takes place with a simultaneous zero position of the gas pedal 1, it is necessary to make use of the characteristic diagrams of the drive engine which were mentioned above.

The fourth controller R₄ in FIG. 3 outputs the actuation signal for an additional restoring force F, with the result that a speed which is set by a cruise controller is implemented. A cruise controller is understood in this context to be a controller which implements the setting and maintenance of a speed v of the motor vehicle which is desired by the vehicle driver. The fourth controller R₄ converts the prescriptions of the cruise controller into a corresponding restoring force at the gas pedal 1, and the vehicle driver is prompted in accordance with this haptic feedback. As already mentioned, the superordinate control unit R₀ is provided for activating or deactivating one or more controllers R₁ to R₄ on the basis of the driving situation or the traffic situation.

FIG. 3 also illustrates a pedal damper 13 which damps disruptive vibrations at the gas pedal 1 and excessively rapid changes in the additional restoring force F which is set. The pedal damper 13 uses a filter to smooth the requirements made of the additional restoring force, in order to give the vehicle driver a pleasant pedal sensation. The communication paths of the specified controllers R₁ to R₄ and of the superordinate control unit R₀, of the coasting distance calculation means 12 and of the pedal damper 13 are illustrated schematically in FIG. 3.

In the superordinate control unit R₀ it is decided, with the aid of a decision logic, which of the controllers R₁ to R₄ is to be active. This logic receives, on the basis of the coasting distance calculation means 12, the information as to whether there is an obstacle which requires immediate coasting or whether the driver's own vehicle is in the follow-on travel mode or whether the route is free. If an obstacle is present which requires immediate coasting, the driver is recommended to adopt a gas pedal position in the unactivated position by selection of the controller R₄. If the vehicle is in the follow-on travel mode behind another vehicle, controller R₂ is activated. In the case of a free route, the optimum gas pedal position profile for acceleration is predefined to the driver automatically until the speed set in the cruise controller is reached. During the acceleration travel, the controller R₁ is active. Subsequently, controller R₄ becomes active and adjusts the speed to that set in the cruise controller.

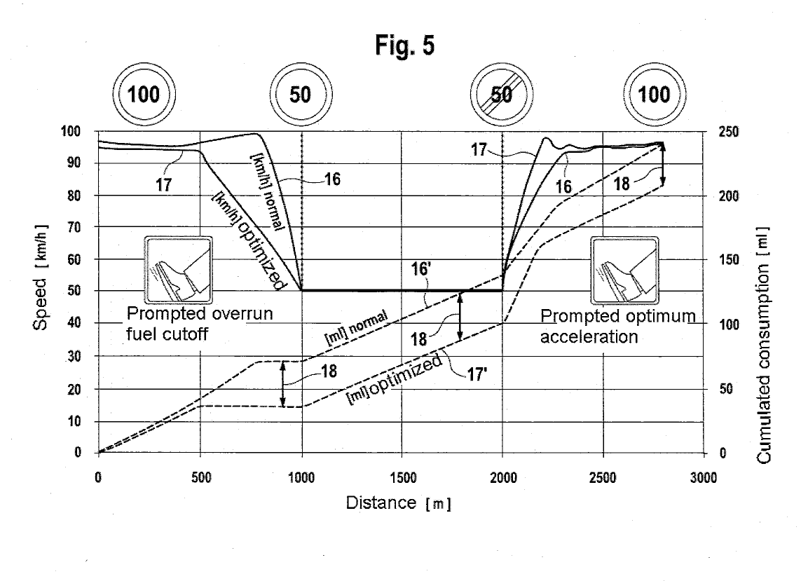

FIGS. 5 to 7 explain three different traffic situations in order to clarify the described method. In FIG. 5, the traffic situation is travelled through with a temporary speed restriction. The starting speed is just 100 km/h. At a distance of 1000 m, there is an entry to a locality with a speed limit of 50 km/h. The length of the locality is 1000 meters. After this, it is possible to accelerate again to 100 km/h. The overall distance of the maneuver is 2800 meters here. The speed curve which is provided with the reference number 16 and the associated curve of the cumulated consumption 16′ originate from a comparison vehicle which has travelled along the same distance without a previously described device and without the described method. In comparison with the speed curve 17 and the consumption curve 17′, which were obtained with the method just described, the following is found: up to the entry into the locality at the distance point P=1000 m, the vehicle driver is brought in a more uniform fashion up to the existing speed limit, while the comparison driver remains for a longer time at the high speed of just under 100 km/h, and only reduces his speed at a comparatively late time before the locality at the distance point P=1000 m. The fact that a locality with a speed limit lies directly ahead can be determined with the aid of an electronically stored road map in conjunction with a satellite-supported position-determining system. The prompted vehicle driver with the speed curve 17 profits here from the prompted overrun fuel cutoff, as prescribed by the controller R₃. The result is shown by the difference 18 between the “normal” and the “optimized” consumption using the present method. In the locality between the distance points P=1000 m and P=2000 m, both speed curves 16 and 17 are congruent at a speed of v=50 km/h. The consumption of energy or fuel cannot differ when the vehicle travels through the locality. At the end of the locality, at the distance point P=2000 m, the prompted vehicle driver accelerates more quickly. The speed curve 17 is therefore located above the comparison curve 16. As has already been mentioned, it may be advantageous to travel through operating points of the drive engine with a poor efficiency level more quickly in order to arrive earlier at operating points of the drive engine with a particularly good efficiency level. By means of this prompted acceleration travel, which has already been described on the basis of the controller R₁, the energy is also used particularly efficiently. This is apparent from the difference 18 in the cumulated consumption.

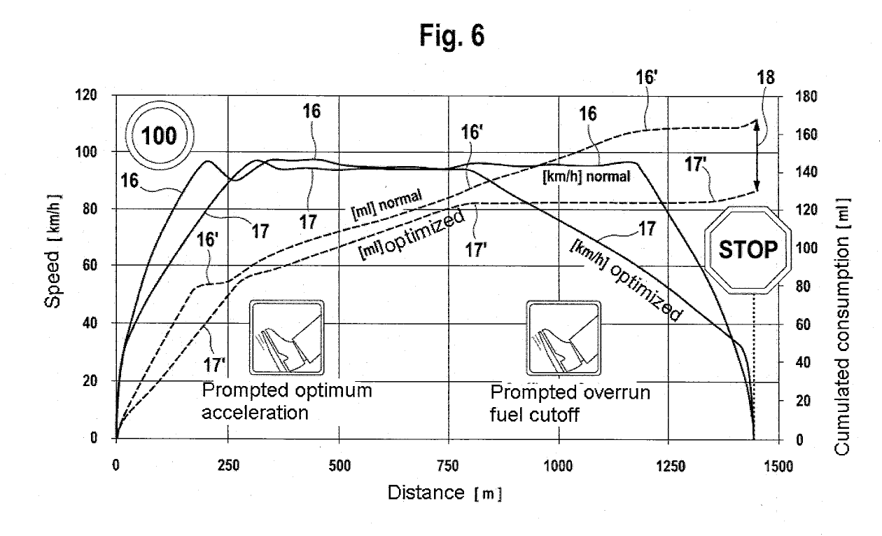

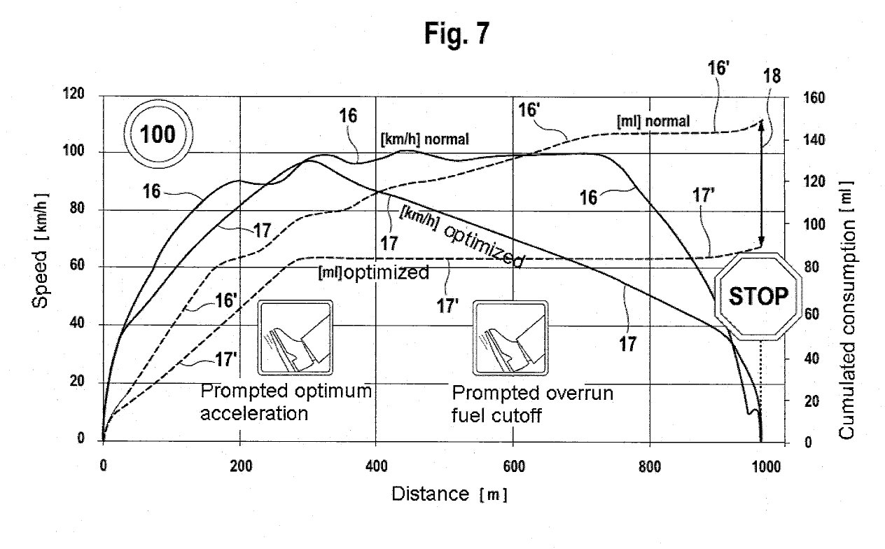

In FIGS. 6 and 7, the speed curve which is obtained with the described method and by using the described device is in turn denoted by the reference number 17, and the associated consumption curve by 17′. A comparison curve without the described method is in turn denoted by 16 and 16′. FIG. 6 illustrates the stop & go traffic situation. The vehicle is accelerated from the stationary state to 100 km/h. Constant travel then follows, and after this the vehicle is decelerated again to 0 km/h. The overall distance is 1500 meters here. The speed curve 17 achieved with the described method rises less steeply up to the distance point P=200 m, that is to say the vehicle driver will accelerate less strongly here since the controller R₁ provides him with an additional opposing force F on the accelerator pedal 1, which force prompts him to accelerate less strongly. However, the result is that at a distance point P=250 m, the consumption curves 17′ and 16′ differ only very slightly. The relatively large saving in energy can be achieved during the deceleration travel of the motor vehicle: while the speed curve 17 already falls slowly starting from the distance point P=800 m, and the motor vehicle is therefore brought comparatively slowly to a stationary state in the prompted overrun fuel cutoff mode of the drive engine, the comparison driver still travels on up to the distance point P=1200 m at the maximum speed of approximately 100 km/h and then subsequently reduces his speed more quickly in order to be in the stationary state at the destination point P=1500 m. However, for this purpose the information that the vehicle has to be in the stationary state at the destination point P=1500 m must already be available at the distance point P=800 m. This information can be transferred from a vehicle which is already at the destination point by car-to-car communication, since the other vehicle is already, for example, at the end of a traffic jam. The energy saving just mentioned is clarified by the difference 18 between the cumulated consumption curve 17′ according to this method and the comparison consumption curve 16′ without driver prompting.

FIG. 7 shows more clearly the enormous potential for saving energy. Similarly to the stop & go traffic situation according to FIG. 6, the vehicle is also accelerated from the stationary state to 100 km/h in the traffic situation illustrated in FIG. 7. This is then followed by constant travel, after which the vehicle is decelerated again to 0 km/h. The overall distance is, however, only 1000 meters here. The prompted acceleration by the controller R₁ leads to a situation in which the speed curve 17 approaches the target speed of 100 km/h more slowly than the comparison curve 16. The prompted overrun fuel cutoff leads to a situation in which the speed is already reduced starting from the distance point P=300 m (see speed curve 17). In contrast, the comparison driver remains at the maximum speed of 100 km/h up to the distance point P=750 m, and only decelerates the comparison vehicle starting from this distance point P=750 m. The difference 18 in the cumulated consumption shows in turn the energy efficiency of the described method and of the device which is presented.

An energy-efficient driving style includes the gear speed to be selected in a manual transmission being proposed to the vehicle driver during the described driving situations of acceleration travel, constant travel and deceleration travel.

The essential idea of the described method is to extend a device which is described at the beginning for generating an additional restoring force at the gas pedal with respect to the functionality of energy-efficient driving. In combination with a surroundings sensor system or a driver assistance system it is therefore possible to travel through various driving situations in an energy-efficient fashion.

The subject of reducing fuel or reducing emissions is a global problem of automobile industries throughout the world. The described method and the corresponding device can be used throughout the world to significantly reduce the emissions which are caused by individual mobility. The method and the device can also be used in local passenger transportation systems, for example in buses, and in goods transportation, for example in trucks.

1.-16. (canceled)

17. A method for operating a device for generating an additional restoring force at a gas pedal of a motor vehicle, wherein a change in position of the gas pedal relative to its initial position, which change is brought about by a corresponding activation force counter to a restoring force, leads to an increase in a driving force of a drive engine, and when the activation force diminishes the restoring force returns the gas pedal in a direction of its initial position, the method comprising:
applying the additional restoring force (F) which acts in a restoring direction of the gas pedal with an actuator element,
wherein a magnitude of the additional restoring force (F) acting on the gas pedal is configured in such a way that the gas pedal assumes a position which moves an operating point of the drive engine into a region with a relatively high efficiency level.

18. The method as claimed in claim 17, wherein the magnitude of the additional restoring force (F) acting on the gas pedal is set as a function of a driving situation and a traffic situation of the motor vehicle.

19. The method as claimed in claim 17, wherein a negative additional restoring force (F) acting on the gas pedal causes the vehicle driver to apply an activation force in a direction of increasing the driving force of the drive engine.

20. The method as claimed in claim 18, wherein the driving situation of the motor vehicle is divided into acceleration travel, constant travel and deceleration travel.

21. The method as claimed in claim 20, wherein the magnitude of the additional restoring force (F) acting on the gas pedal during acceleration travel is configured in such a way that the gas pedal assumes an optimum position, wherein the optimum position of the gas pedal is determined as a function of the efficiency level of the drive engine.

22. The method as claimed in claim 20, wherein the magnitude of the additional restoring force (F) acting on the gas pedal during deceleration travel is configured in such a way that the gas pedal assumes an unactivated position.

23. The method as claimed in claim 22, wherein in order to initiate the deceleration travel, a coasting distance before a stationary obstacle or an obstacle which is moving in the direction of travel of the motor vehicle is calculated and is compared with a predetermined coasting curve of the motor vehicle.

24. The method as claimed in claim 20, wherein the driving situation is determined, on the one hand, on the basis of dynamic variables including at least one of velocity, longitudinal acceleration, lateral acceleration and yawing moment and, on the other hand, on the basis of vehicle-internal variables including at least one of engine control parameters and transmission control parameters.

25. The method as claimed in claim 18, wherein the traffic situation is determined by a surroundings sensor system for sensing a carriageway, a route, road signs and/or stationary or moving obstacles and/or road users.

26. The method as claimed in claim 18, wherein the traffic situation is determined with the aid of an electronically stored road map in conjunction with a satellite supported position-determining system.

27. The method as claimed in claim 20, wherein the acceleration travel, constant travel or deceleration travel is detected as a function of the traffic situation, and the additional restoring force (F) acting on the gas pedal is configured in such a way that the motor vehicle is guided in an energy-efficient fashion.

28. The method as claimed in claim 20, wherein a gear speed to be selected in a manual transmission is proposed to the vehicle driver in the case of acceleration travel, constant travel and deceleration travel.

29. A device for generating an additional restoring force at a gas pedal of a motor vehicle, relative to its initial position, wherein a change in position of the gas pedal, which change is brought about by a corresponding activation force counter to a restoring force, leads to an increase in a driving force of a drive engine, and when the activation force diminishes a restoring force returns the gas pedal in a direction of its initial position, the device comprising:
an actuator element which applies the additional restoring force (F) which acts in a restoring direction of the gas pedal; and
means (R₀ to R₄) are provided which configure a magnitude of the additional restoring force (F) acting on the gas pedal in such a way that the gas pedal assumes a position which moves the operating point of the drive engine into a region with a relatively high efficiency level.

30. The device as claimed in claim 29, wherein the means (R₀ to R₄) detect at least one of acceleration travel, constant travel or deceleration travel as a function of a driving situation and/or a traffic situation, and configure the additional restoring force (F) acting on the gas pedal in such a way that the motor vehicle is guided in an energy-efficient fashion.

31. The device as claimed in claim 29, wherein the means (R₀ to R₄) are embodied as controllers (R₁ to R₄),
wherein the first controller (R₁) outputs the additional restoring force (F) which corresponds to an optimum gas pedal position during acceleration and which acts on the gas pedal, and
wherein the second controller (R₂) outputs the additional restoring force (F) acting on the gas pedal for the purpose of follow-on travel behind another road user, and
wherein the third controller (R₃) outputs the additional restoring force (F) acting on the gas pedal in order to decelerate the motor vehicle, with the result that the gas pedal assumes an unactivated position, and
wherein the fourth controller (R₄) outputs the additional restoring force (F) acting on the gas pedal, with the result that a speed which is set by a cruise controller is implemented, and
wherein a superordinate control unit (R₀) is provided which activates or deactivates one or more controllers (R₁ to R₄) on the basis of a driving situation and/or a traffic situation.

32. The device as claimed in claim 31, wherein a surroundings sensor system is provided which provides the superordinate control unit (R₀) with information about a carriageway, a route, road signs and/or stationary or moving obstacles and/or road users.

33. The method as claimed in claim 21, wherein the optimum position of the gas pedal is determined based on predetermined characteristic diagrams of the drive engine.
